(19) United States
(12) Patent Application Publication
(10) Pub. No.: US 2006/0053180 A1
(43) Pub. Date: Mar. 9, 2006

(54) Method for inspecting an archive

(76) Inventors: Galit Alon, Haifa (IL); Yanki Margalit, Ramat Gan (IL); Dany Margalit, Ramat Chen (IL)

Correspondence Address: HOFFMAN, WASSON & GITLER, P.C., Crystal Center 2 - Suite 522, 2461 South Clark Street, Arlington, VA, 22202, US

(21) Appl. No.: 11/028,594

(22) Filed: Jan. 5, 2005

Related U.S. Application Data
(60) Provisional application No. 60/607,709, filed on Sep. 8, 2004.

(51) Int. Cl. G06F 17/30

(52) U.S. Cl. 707/204

(57) ABSTRACT

A method for inspecting an archive, the method comprising the steps of: retrieving information from a header of the archive, such as a compression ratio of one or more files of the archive, the average compression ratio of the archive, an expression of the compression ratio of one or more files of the archive, the size of the archive and the number of files stored within the archive, and employing said information for inspecting the archive.

### REFERENCE TO RELATED APPLICATIONS

Reference is made to U.S. Provisional Patent Application Serial No. U.S. 60/607,709, entitled “A method to detect viruses hidden inside a password protected archive or compressed files”, filed Sep. 8, 2004, the disclosure of which is hereby incorporated by reference and priority of which is hereby claimed pursuant to 37CFR 1.78(a)(4) &(5)(i).

### FIELD OF THE INVENTION

The present invention relates to the field of computer virus detection. More particularly, the present invention relates to a method for detecting virus infected executables within a file stored within an archive file.

### BACKGROUND OF THE INVENTION

Archives such as ZIP, RAR, etc. are used for storing one or more files. Typically, files stored within an archive (referred herein as “local files”) are stored (i.e. stored within an archive) in a compressed manner in order to decrease the storage volume. Furthermore, local files may also be stored in an encrypted form, in order to prevent exposing their content by unauthorized objects. The compression and/or encryption convert the content of a file to a form which is different from the original. Thus, prior to inspecting (i.e. scan for viruses, etc.) an archive file, the local files stored within the archive have to be decompressed, and therefore an anti-virus utility is not effective for encrypted executables stored within an archive since usually the anti-virus utility doesn't have the key for decrypting the encrypted files, and even if it has, it still takes time and processing effort for decompression.

Since archives are common in Internet data communication, especially in email messages, it is an object of the present invention to provide a solution for inspecting an archive. Other objects and advantages of the invention will become apparent as the description proceeds.

### SUMMARY OF THE INVENTION

The present invention is directed to a method for inspecting an archive, the method comprising the steps of: retrieving information from a header of the archive and employing the information for inspecting the archive.

The information may be, for example, a compression ratio of one or more files of the archive, the average compression ratio of the files of the archive, an expression of the compression ratio of one or more files of the archive, the size of the archive and the number of files stored within the archive.

The inspection may be carried out, for example, by comparing the compression ratio of an executable stored within the archive with a threshold, and indicating that the executable is infected by a virus if the compression ratio is less than the threshold.

According to a preferred embodiment of the invention, the threshold is about 4 percent.

According to one embodiment of the invention, the inspection is carried out by comparing the average compression ratio of the archive with a threshold, and indicating that the executable is infected by a virus if the compression ratio is less than the threshold.

According to another embodiment of the invention, the inspection is carried out by comparing the average compression ratio of the executables of the archive with a threshold, and indicating that the executable is infected by a virus if the compression ratio is less than the threshold.

According to yet another embodiment of the invention, the inspection is carried out by: comparing the compression ratio of an executable of the archive with a threshold; indicating that the executable is suspected to be infected by a virus if the compression ratio is between a first threshold and a second threshold.

According to one embodiment of the invention, the compression ratio is about 4 percent.

According to one embodiment of the invention, the second compression ratio is about 10 percent.

The method may further comprise determining if the executable is infected by a virus by additional testing thereof, such as, for example, testing to determine whether the overall compression ratio of the archive is less than a third threshold and whether the number of files stored within the archive is less than a fourth threshold. According to one embodiment of the invention, the third threshold is 50 KB. According to one embodiment of the invention, the fourth threshold is 3 files.

### BRIEF DESCRIPTION OF THE DRAWINGS

The present invention may be better understood in conjunction with the following figures:

FIG. 1 illustrates a ZIP archive as viewed by a Hex viewer, according to the prior art.

FIG. 2 illustrates an archive file as viewed by a Hex viewer, according to the prior art.

FIG. 3 is a flowchart of a method for inspecting an archive, according to a preferred embodiment of the invention.

FIG. 4 is a flowchart of a test for indicating virus infection on a local file of an archive, according to a preferred embodiment of the invention.

FIG. 5 is a flowchart illustrating testing for indicating whether an archive file comprises an infected file according to a preferred embodiment of the invention.

### DETAILED DESCRIPTION OF PREFERRED EMBODIMENTS

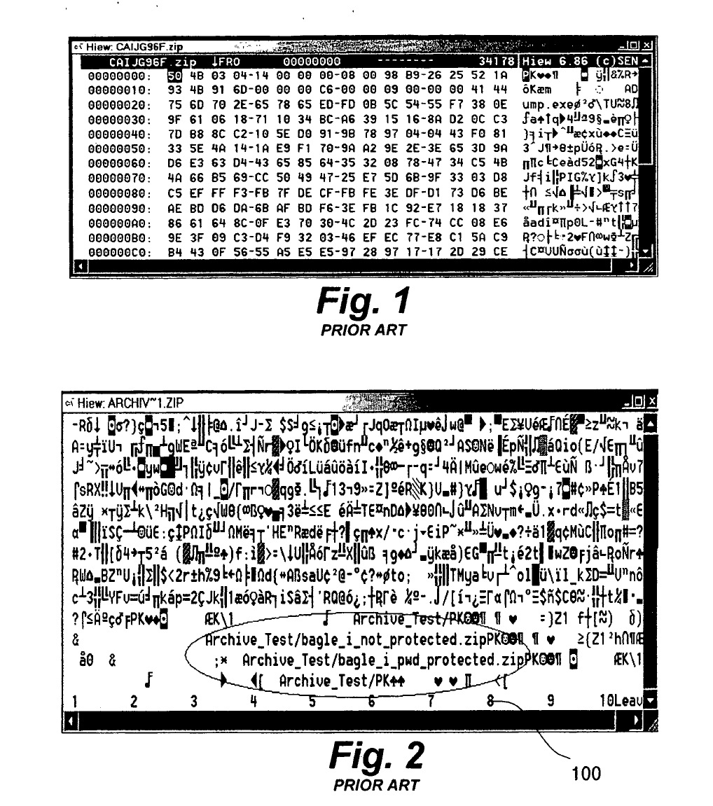

FIG. 1 illustrates a ZIP archive, a typical example of an archive file, as viewed by a Hex viewer, according to the prior art. The ZIP archive includes one or more local files. The general format of each local file includes three parts: a local file header, file data and a data descriptor.

The parts of a local file are described on http://www.pkware.com/ as follows:

A. Local File Header:

| | |
|---|---|
| local file header signature | 4 bytes |
| | (0x04034b50) |
| version needed to extract | 2 bytes |
| general purpose bit flag | 2 bytes |
| compression method | 2 bytes |
| last mod file time | 2 bytes |
| last mod file date | 2 bytes |
| crc-32 | 4 bytes |
| compressed size | 4 bytes |
| uncompressed size | 4 bytes |
| file name length | 2 bytes |
| extra field length | 2 bytes |
| file name (variable size) | |
| extra field (variable size) | |

B. File Data

Immediately following the local header for a file is the compressed or stored data for the file. The series of [local file header][file data][data descriptor] repeats for each file in the .ZIP archive.

C. Data Descriptor:

| | |
|---|---|
| crc-32 | 4 bytes |
| compressed size | 4 bytes |
| uncompressed size | 4 bytes |

FIG. 2 illustrates an archive file as viewed by a Hex viewer, according to the prior art. It should be noted that although the content of an archive file is “unreadable”, the header 100 (also emphasized by a circle) of the files stored within the archive is “readable”, i.e. its information is not encrypted and therefore it is meaningful.

Applicants have discovered that the typical compression ratio of executables infected by a virus is between 0% and 4%, while the typical compression ratio of non-infected executables is usually higher than 10%. Accordingly, it is a particular feature of the present invention that since the compression ratio of an executable stored within an archive can be determined, a determination of whether the executable is infected by a virus can be carried out by employing the header content, even without unpacking the local file, e.g. returning a file stored within an archive to its original form.

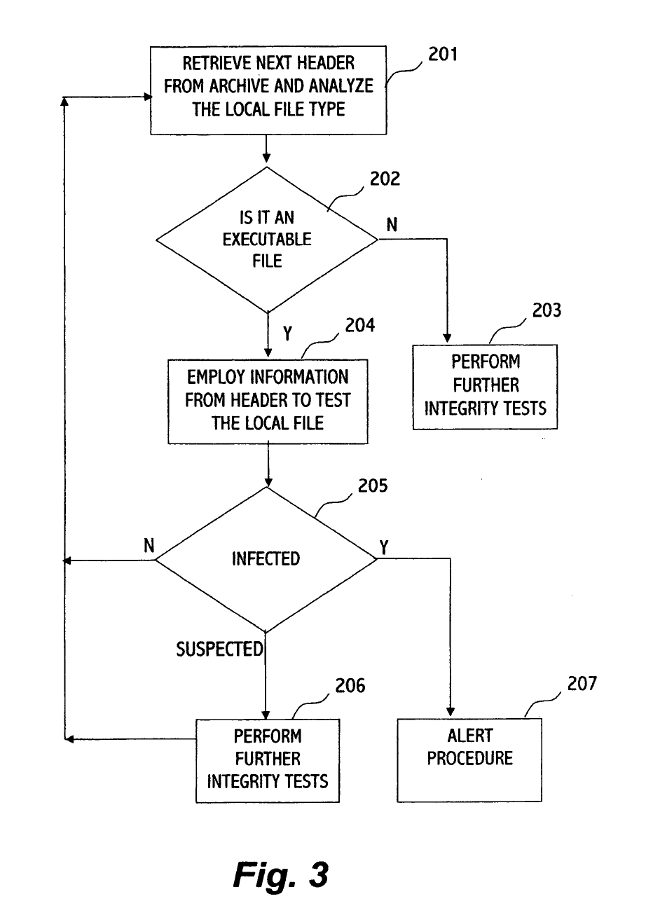

Reference is now made to FIG. 3, which is a simplified flowchart of a method for inspecting an archive, according to a preferred embodiment of the invention.

Assuming all the files of an archive are processed, at block 201 the header of the next local file is retrieved, and the type of the local file is analyzed. The type can be indicated, for example, by the extension of a file, by its first bytes, etc. For example, “EXE” is the extension of Windows® executables, “COM” is the extension of DOS® executables.

From block 202, if the file is an executable, the flow continues to block 204, otherwise, the flow continues to block 203, where further integrity tests may be carried out. Such integrity tests are outside the scope of the present invention. Otherwise, the flow continues to block 204.

At block 204, one or more tests are carried out. The tests are based on the information retrieved from the header, and are detailed hereinbelow.

At block 205, if the testing of block 204 indicates that the local file is not infected by a virus, such as, for example, a malicious code, the flow continues to step 201, where the next header entry is retrieved from the archive file. If the testing at of block 204 indicates that the local file is infected by a virus, then at block 207 an alert procedure, such as, for example, warning the user and deleting the infected file from the archive, is carried out. However if the testing indicate only suspicion and cannot determine with a high certainty whether or not the file is infected by a virus, then the flow continues to block 206, where further tests are performed, and then continues to block 201, where the next header entry is retrieved from the archive.

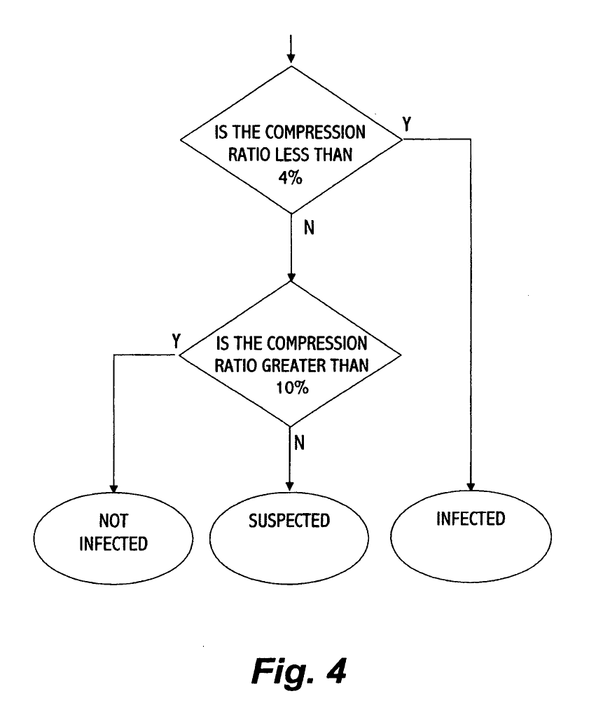

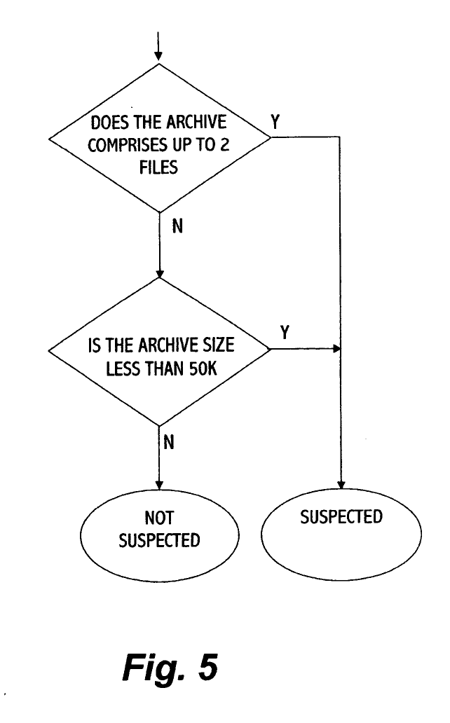

Reference is now made to FIG. 4, which is a simplified flowchart of a test for indicating virus infection on a local file of an archive, according to a preferred embodiment of the invention. As described above, a meaningful test for indicating whether an executable stored within an archive is infected by a virus is the presence of a low compression ratio.

As noted above, applicants have found that if the compression ratio of an executable is between 0% and 4%, defined as a low compression ratio, then there is a high certainty that the executable is infected by a virus and that a compression ratio greater than 10% indicates to a high certainty that the file is not infected by a virus. Thus, a compression ratio greater that 4% but smaller than 10% may indicate a suspicion that the executable is infected by a virus. In this case further tests should be carried out in order to determine if the file is indeed infected, or not. As mentioned above, the values used herein, i.e. 0%, 4% and 10%, are based on a research carried out by applicants. Other suitable values may be used as thresholds.

Reference is now made to FIG. 5, which is a simplified flowchart of testing for indicating whether an archive file contains one or more infected files according to a preferred embodiment of the invention. The testing is preferably based on one or more of the following: a realization of applicants that many infected archives include up to two file and a realization that the overall size of a typical infected archive file is less than 50 K bytes. These realizations find expression in the flowchart of FIG. 5.

Thus, in addition to testing each executable file separately, the archive can be tested as a whole, e.g. indicating infection by the average compression ratio of the archive's files or executables. According to yet another embodiment of the invention, a combination of examination each local file along with examination of the entire archive may be used for inspecting the archive. For example, if the compression ratio of an executable is 7%, and its volume is greater than 50 K, then the file can be determined to be non-infected. However, if the compression ratio of an executable is 7%, and its volume is less than 50 K, then the file can be determined to be infected by a virus.

It should be noted that the present invention is effective even in cases where the stored files are not encrypted, and thus can be decompressed and inspected by virus detection methods known in the art. This is because the present invention allows inspecting an archive even without unpacking its files, thereby enabling inspection of an archive with less processing effort and time than was previously possible.

Those skilled in the art will appreciate that the invention can be implemented on a junction of Internet traffic (such as a gateway to a network, a mail server, etc.) as well as on a personal computer by an anti-virus software, etc.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A method for inspecting an archive, the method comprising the steps of:
retrieving information from a header of said archive; and
employing said information for inspecting said archive.

2. A method according to claim 1, wherein said information is selected from a group comprising: a compression ratio of one or more files of said archive, the average compression ratio of said archive, an expression of the compression ratio of one or more files of said archive, the size of said archive, and the number of files stored within said archive.

3. A method according to claim 1, wherein said inspecting is carried out by comparing the compression ratio of an executable stored within said archive with a threshold, and indicating that said executable is infected by a virus if said compression ratio is less than said threshold.

4. A method according to claim 3, wherein said threshold is about 4 percent.

5. A method according to claim 1, wherein said inspecting is carried out by comparing the average compression ratio of said archive with a threshold, and indicating that said executable is infected by a virus if said compression ratio is less than said threshold.

6. A method according to claim 1, wherein said inspecting is carried out by comparing the average compression ratio of the executables of said archive with a threshold, and indicating that said executable is infected by a virus if said compression ratio is less than said threshold.

7. A method according to claim 1, wherein said inspecting is carried out by:
comparing the compression ratio of an executables of said archive with a threshold;
indicating that said executable is suspected to be infected by a virus if said compression ratio is between a first threshold and a second threshold.

8. A method according to claim 7, wherein said first compression ratio is about 4 percent.

9. A method according to claim 7, wherein said second compression ratio is about 10 percent.

10. A method according to claim 7, further comprising determining if said executable is infected by a virus by additional test(s) thereof.

11. A method according to claim 10, wherein said additional test(s) is/are selected from a group comprising: overall compression ratio of said archive is less than a third threshold, number of files stored within said archive is less than a fourth threshold.

12. A method according to claim 12, wherein said third threshold is 50 KB.

13. A method according to claim 12, wherein said fourth threshold is 3 files.
